(19) United States
(12) Patent Application Publication
(10) Pub. No.: US 2020/0326222 A1
(43) Pub. Date: Oct. 15, 2020

(54) Fluid Level Detection Apparatus

(71) Applicant: James Cody Connell, Carlsbad, NM (US)

(72) Inventor: James Cody Connell, Carlsbad, NM (US)

(21) Appl. No.: 16/383,652

(22) Filed: Apr. 14, 2019

(51) Int. Cl. G01F 23/24

(52) U.S. Cl. CPC G01F 23/243; G01F 23/242

(57) ABSTRACT

A fluid level detection apparatus for sensing a fluid level of a liquid in within a container, the apparatus including electrically conductive first and second members each having proximal and distal end portions both in an initial circuit state. Also included in the apparatus is control circuitry that is operative to monitor the first and second proximal end portions to produce a primary perceptible output in response to the first and second distal end portions forming an auxiliary circuit state from the initial circuit state, wherein operationally the first and second distal end portions are disposed within the container moving from the initial circuit state to the auxiliary circuit state with a presence of the liquid in the container with the liquid in contact with the first and second distal end portions to ultimately indicate a primary liquid level resulting in the primary perceptible output.

### TECHNICAL FIELD

The present invention relates generally to fluid level detecting devices for sensing a liquid level in a container with optional container liquid filling capabilities that can be in combination with the fluid level detecting device. More particularly, the present invention relates to the container being a Christmas tree watering stand with progressive water level indication along with the ability to replenish tree watering stand with water.

### BACKGROUND OF INVENTION

Fluid sensors are well known in the prior art for typical applications of monitoring a liquid level in a fixed tank via using a float or some electrical discontinuity based on conductivity of the liquid, wherein usually the fluid sensor is affixed to the fixed tank. The present invention employs a portable liquid level sensor that is not affixed to the tank and can be freely moved to different tanks if needed and giving an indication of progressive liquid level within the tank if desired. In Christmas tree watering it is important that the tree watering container does not go dry that will cause the tree trunk end to dry out and tend to close and restrict tree trunk water absorption, thus it is important to keep the container from going dry through water level monitoring without the inconvenience of looking under the tree to check the water level in the container. In addition the optional feature of remotely filling the tree water container at say waist level for instance without having to fill the water container at a tree trunk level further makes maintaining the water in the tree trunk container easier.

Looking at the prior art starting with U.S. Pat. No. 10,188,234 to Sullivan, discloses a Christmas tree moisture sensor providing visual and audio alerts, wherein the sensor mounts to the Christmas tree trunk resulting in the visual and audio adjacent to the Christmas tree water bowl being inconveniently low and next to the floor. In Sullivan, the water level is sensed by a conductive probe that just senses a single water level threshold to indicate from.

Continuing in the prior art in U.S. Pat. No. 10,028,455 to Ference, disclosed is a Christmas tree ornament with a water pump having a control system that utilizes a remote sensor. Further, in U.S. Pat. No. 7,886,483 to Solak, disclosed is a Christmas tree water bowl water level sensor solely detecting only full and empty based on a float switch, sending an electrical signal only, there is no provision for filling the bowl.

Next in the prior art in U.S. Pat. No. 7,757,435 to Boskofsky, disclosed is a Christmas tree ornament that acts as a funnel and water supply, wherein the bottom of the ornament has a shut off valve to stop flow when the ornament is changed (from empty to full), however, no water level sensing is taught. In U.S. Pat. No. 7,757,434 to Naclerio, disclosed is a Christmas tree ornament that acts as a funnel and water supply, similar to Boskofsky above, however, with the addition of a float valve that meters the water allowed into the lower bowl from the water supply.

Continuing in the prior art in U.S. Pat. No. 6,760,998 to Montijo, discloses again a Christmas tree ornament that acts as a funnel and water supply, however, having tubing to a multitude of trunk injectors that are pierced into the trunk bark. In U.S. Pat. No. 6,167,651 to Luddy, again disclosed is a Christmas tree ornament that acts as a funnel and water supply to the tree stump bowl, wherein there is no teaching of water level sensing. Also in U.S. Pat. No. 6,082,043 to Andrews, disclosed is a Christmas tree ornament that acts as a funnel and water supply, also having an electronic single level output indicator to signal to refill the ornament with water.

Next in the prior art in U.S. Pat. No. 6,073,390 to Baudier, discloses again a Christmas tree ornament that acts as a funnel and water supply, further including a float and a mechanical bell to signal that the tree bowl is full. Further, in U.S. Pat. No. 5,867,929 to Jung, disclosed is a Christmas tree ornament (snowman) that acts as a funnel and water supply, further having an float alarm for water level in the tree bowl. Also in U.S. Pat. No. 5,615,516 to Brown, discloses again a Christmas tree ornament that acts as a funnel and water supply, further including a ornament filling port for convenience.

Continuing in the prior art in U.S. Pat. No. 5,473,838 to Denbigh, discloses again a Christmas tree ornament that acts as a funnel and water supply, further including tree attachment particulars, however, there is no water level indication. In addition in U.S. Pat. No. 5,054,236 to Sands, discloses again a Christmas tree ornament that acts as a funnel and water supply, further including a float ball valve to regulate water to a single level in the tree bowl. Also in U.S. Pat. No. 4,796,017 to Merenda, discloses a single low level Christmas tree stand water alarm using an electronic water level sensor in a Christmas tree ornament enclosure. Plus in U.S. Pat. No. 7,765,736 to Lloyd, disclosed is a Christmas tree stand with built in reservoir for water that has a float valve at its distal end for single level water feed.

Moving onward in the prior art in U.S. Pat. No. 7,147,014 to Chien, discloses again a Christmas tree stand and water feed combination with a single level sensor. Further in United States Patent Application Publication Number US 2018/0125022 to Moran, discloses again a Christmas tree watering system with a separate reservoir and pump that has high/low water level fluid contact sensors. Plus in United States Patent Application Publication Number US 2018/0105409 to Bernaski, discloses a Christmas tree watering funnel with tube having a manual valve.

This gives an idea of the current state of the art in the Christmas tree watering arts, wherein Sullivan and Moran have fluid level sensing, as Sullivan just has the water level probe designed for Christmas tree bowls and Moran has the floor mounted reservoir with a high/low water level sensor, the remaining references are various funnel tube or small reservoirs (ornament) with tube feeding the tree bowl with some having float valves or manual valves.

What is needed is a progressive fluid level indication (as none of the cited references has this), with the progressive fluid level indication being in combination with the fill funnel & tube, and plus the progressive fluid level structural specifics as being attached to tube to accommodate fluid level sensing in a bowl shape, meaning that with the unique tube based level sensing, with the level sensor not being affixed to the fluid vessel.

### SUMMARY OF INVENTION

Broadly, the present invention is for a fluid level detection apparatus for sensing a varying fluid level of a liquid in within a container interior volume, the fluid level detection apparatus including a first member having a first proximal end portion and an opposing first distal end portion with a first longitudinal axis spanning therebetween, wherein the first member is constructed of an electrically conductive material that is in an initial circuit state. Further included in the fluid level detection apparatus is a second member having a second proximal end portion and an opposing second distal end portion with a second longitudinal axis spanning therebetween, wherein the second member is constructed of an electrically conductive material that is in an initial circuit state.

Continuing, also included in the fluid level detection apparatus is control circuitry that is operative to monitor the first and second proximal end portions to produce a primary perceptible output in response to the first and second distal end portions forming an auxiliary circuit state from the initial circuit state, wherein operationally the first and second distal end portions are disposed within the container interior volume moving from the initial circuit state to the auxiliary circuit state with a presence of the liquid in the container with the liquid in contact with the first and second distal end portions to ultimately indicate a primary liquid level.

These and other objects of the present invention will become more readily appreciated and understood from a consideration of the following detailed description of the exemplary embodiments of the present invention when taken together with the accompanying drawings, in which;

### BRIEF DESCRIPTION OF DRAWINGS

FIG. 1 shows a side elevation view of a Christmas tree including a trunk and container with liquid disposed within the interior volume with the fluid level detection apparatus shown that optionally includes an open end frustoconical shape used as a funnel in liquid communication with a liquid communication line wherein a line end portion was disposed within the container interior volume for refilling of the container interior volume with liquid, also shown is a perceptible output disposed within a housing and a first, second, third, fourth, and fifth member;

FIG. 2 shows a side elevation view of the fluid level detection apparatus that optionally includes the open end frustoconical shape used as the funnel in liquid communication with the liquid communication line wherein the line end portion is disposed within the container interior volume for refilling of the container interior volume with liquid, also shown is the perceptible output disposed within the housing and the first, second, third, fourth, and fifth members;

FIG. 3 shows an electronic schematic diagram of control circuitry that includes a power supply, a momentary contact switch, resistors, led's, and the first, second, third, fourth, and fifth members all enclosed within a housing, also shown is the container, the interior volume of the container, and the liquid level that is at the tertiary liquid level;

FIG. 4 shows an electronic schematic diagram of control circuitry that includes the power supply, the momentary contact switch, resistors, led's, and the first, second, third, fourth, and fifth members all enclosed within the housing, also shown is the container, the interior volume of the container, and the liquid level that is at the primary liquid level; and

FIG. 5 shows an electronic schematic diagram of control circuitry that includes the power supply, the momentary contact switch, resistors, led's, and the first, second, third, fourth, and fifth members all enclosed within the housing, also shown is the container, the interior volume of the container, and the liquid level that is at the secondary liquid level.

### REFERENCE NUMBERS IN DRAWINGS

50 Fluid level detection apparatus
55 Container
60 Interior volume of the container 55
65 Liquid
70 Level of the liquid 65
75 First member can be rigid or flexible
80 First proximal end portion
85 First distal end portion
90 First longitudinal axis
95 Second member can be rigid or flexible
100 Second proximal end portion
105 Second distal end portion
110 Second longitudinal axis
115 Third member can be rigid or flexible
120 Third proximal end portion
125 Third distal end portion
130 Third longitudinal axis
135 Fourth member can be rigid or flexible
140 Fourth proximal end portion
145 Fourth distal end portion
150 Fourth longitudinal axis
151 Fifth member can be rigid or flexible
152 Fifth proximal end portion
153 Fifth distal end portion
154 Fifth longitudinal axis
155 Initial circuit state
160 Control circuitry
165 Auxiliary circuit state
170 First 85 and second 105 distal end portions being disposed within the container 55 interior volume 60
175 Contact of liquid 65 with the first 85 and second 105 distal end portions
180 Primary perceptible output
185 Primary liquid 65 level 70
190 Substantially parallel relationship between the first 90, second 110, and third 130 longitudinal axes
195 Different length of the third distal end portion 125 to the first 85 and second 105 distal end portions
200 Third distal end portion 125 being disposed within the container 55 interior volume 60
201 Fourth distal end portion 145 being disposed within the container 55 interior volume 60
202 Fifth distal end portion 153 being disposed within the container 55 interior volume 60
205 Electrical communication of the control circuitry 160 to the first 80 and second 100 proximal end portions
210 Electrical communication of the control circuitry 160 to the third proximal end portion 120
215 Electrical communication of the control circuitry 160 to the fourth proximal end portion 140
216 Electrical communication of the control circuitry 160 to the fifth proximal end portion 152
220 First 85 and third 125 distal end portions forming an auxiliary circuit state 165
225 Secondary perceptible output
230 Secondary liquid 65 level 70
235 Substantially parallel relationship between the first 90, second 110, third 130, and fourth 150 longitudinal axes
236 Substantially parallel relationship between the first 90, second 110, third 130, fourth 150, and fifth 154 longitudinal axes
240 Different length of the fourth distal end portion 145 to the first 85, second 105, and third 125 distal end portions
241 Different length of the fifth distal end portion 153 to the first 85, second 105, third 125, and fourth 145 distal end portions
245 First 85 and fourth 145 distal end portions forming an auxiliary circuit state 165
246 First 85 and fifth 153 distal end portions forming an auxiliary circuit state 165
250 Tertiary perceptible output
251 Fourth perceptible output
255 Tertiary liquid 65 level 70
256 Fourth liquid 65 level 70
260 Visual display of the primary 180 and secondary 225 perceptible outputs
265 Plurality of lights of the visual display 260
270 Electrical communication of the plurality of lights 265 to the control circuitry 160
275 Visual display of the primary 180, secondary 225, and tertiary 250 perceptible outputs
280 Plurality of lights of the visual display 275
285 Electrical communication of the plurality of lights 280 to the control circuitry 160
290 Housing of the control circuitry 160
295 Independent power supply of the control circuitry 160
300 Maintaining to refill a varying fluid 65 level 70 in the container 55 interior volume 60
305 Open end frustoconical shape
310 Reduced size outlet of the open end frustoconical shape 305
315 Liquid communication line
320 Line end portion of the liquid communication line 315
325 Disposing the line end portion 320 in the container 55 interior volume 60
330 Affixed structure of the first 75 and second 95 members to the liquid communication line 315
335 Adjacent position of the first 85 and second 105 distal end portions to the line end portion 320
340 Affixed structure of the control circuitry 160 to the liquid communication line 315 and/or the frustoconical shape 305
345 Affixed structure of the third member 115 to the liquid communication line 315 or the first 75 and second 95 members
350 Affixed structure of the fourth member 135 to the liquid communication line 315 or the first 75, second 95, and third 115 members
351 Affixed structure of the fifth member 151 to the liquid communication line 315 or the first 75, second 95, third 115, and fourth 135 members
355 Christmas tree
360 Christmas tree stand with water reservoir 55
365 Christmas tree base trunk
370 Perceptible output
375 Plurality of lights for the perceptible output 370 which can be LED's
380 Power supply check indicator perceptible output
385 Momentary switch-normally open
390 Resistors

### DETAILED DESCRIPTION

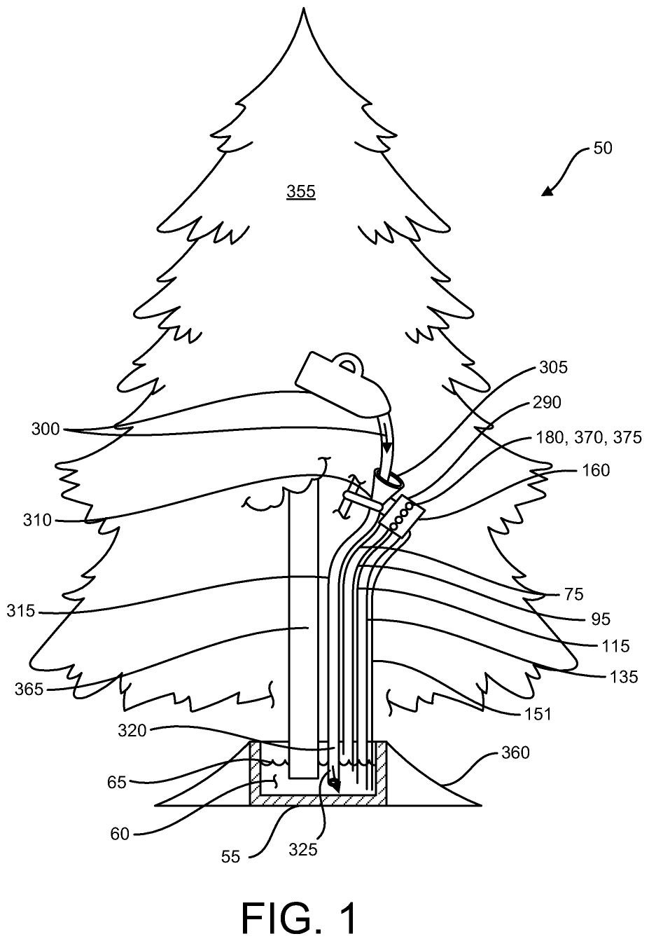

With initial reference to FIG. 1 shown is a side elevation view of a Christmas tree 335 including a trunk 365 and container 55 with liquid 65 disposed within the interior volume 60 forming a Christmas tree stand with water reservoir 360 with the fluid level detection apparatus 50 shown that optionally includes an open end frustoconical shape 305 used as a funnel in liquid communication with a liquid communication line 315 wherein a line end portion 320 was disposed 325 within the container 55 interior volume 60 for refilling of the container 55 interior volume 60 with liquid 65, also shown is a perceptible output 370 disposed within a housing 290 and the first 75, second 95, third 115, fourth 135, and fifth 151 members.

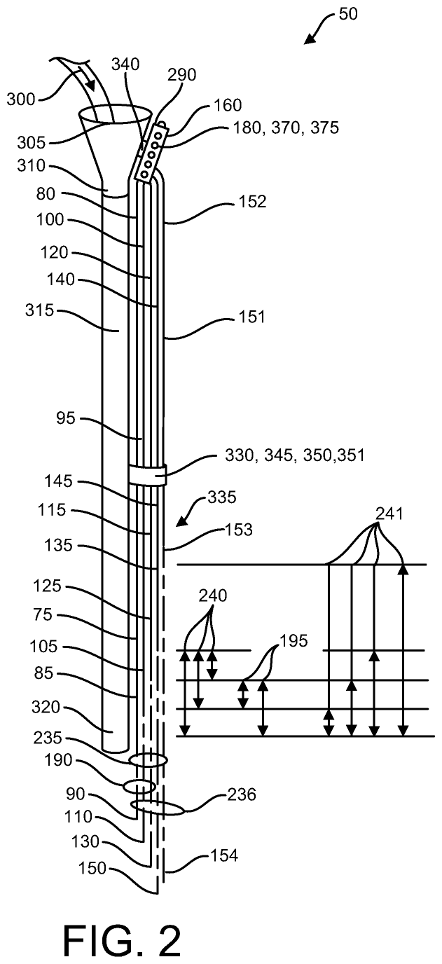

Next, FIG. 2 shows a side elevation view of the fluid level detection apparatus 50 that optionally includes the open end frustoconical shape 305 used as the funnel in liquid communication with the liquid communication line 315 wherein the line end portion 320 is disposed 325 within the container 55 interior volume 60 for refilling of the container 55 interior volume 60 with liquid 65, also shown is the perceptible output 370 disposed within the housing 290 and the first 75, second 95, third 115, fourth 135, and fifth 151 members.

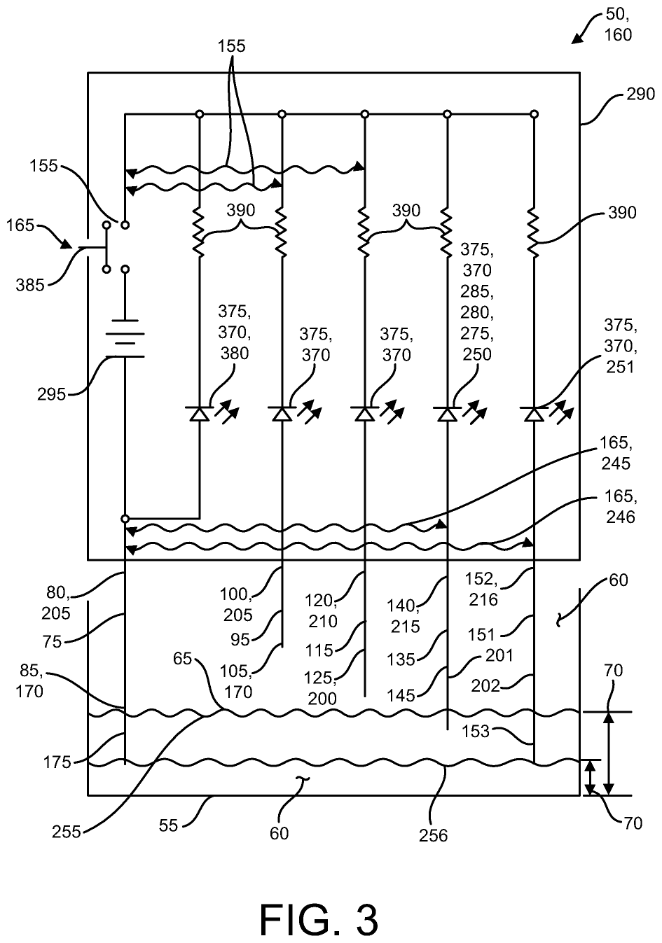

Continuing, FIG. 3 shows an electronic schematic diagram of control circuitry 160 that includes a power supply 295, a momentary contact switch 385, resistors 390, led's 375, and the first 75, second 95, third 115, fourth 135, and fifth 151 members all enclosed within a housing 290, also shown is the container 55, the interior volume 60 of the container 55, and the liquid level 70 that is at the tertiary liquid level 255.

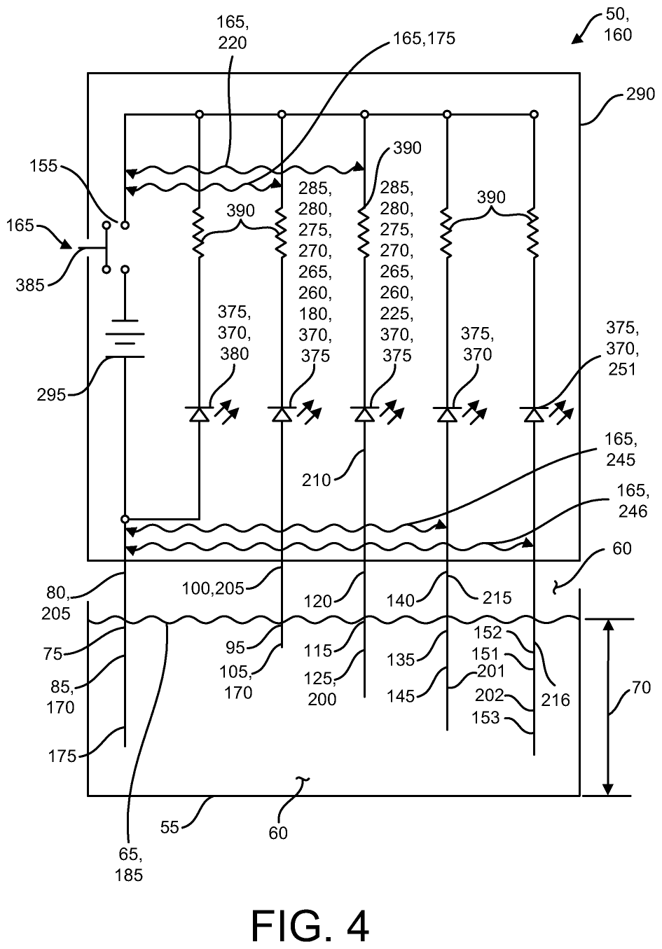

Moving onward, FIG. 4 shows an electronic schematic diagram of control circuitry 160 that includes the power supply 295, the momentary contact switch 385, resistors 390, led's 375, and the first 75, second 95, third 115, fourth 135, and fifth 151 members all enclosed within the housing 290, also shown is the container 55, the interior volume 60 of the container 55, and the liquid level 70 that is at the primary liquid level 185.

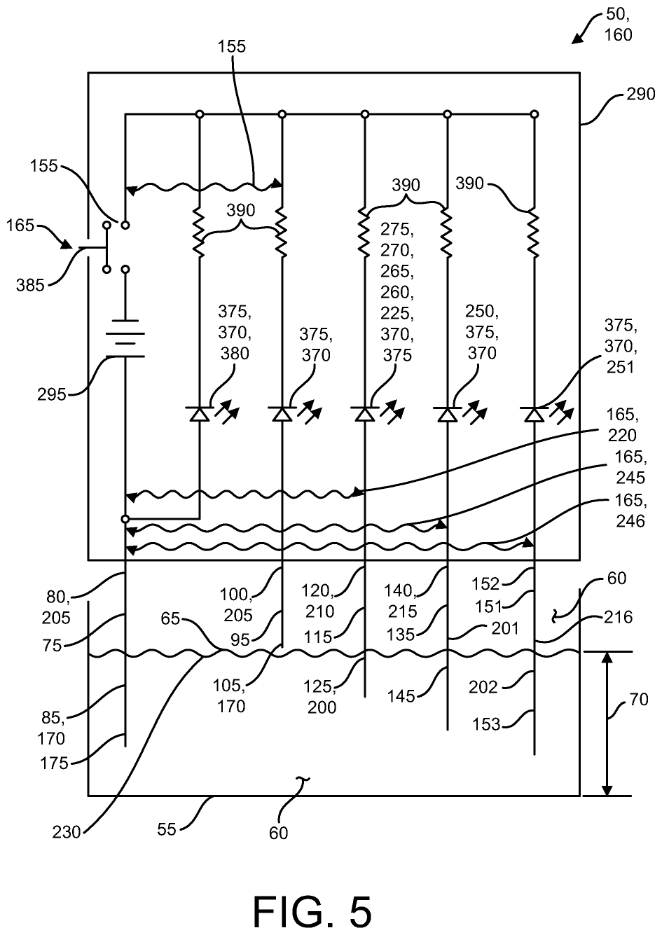

Further, FIG. 5 shows an electronic schematic diagram of control circuitry 160 that includes the power supply 295, the momentary contact switch 385, resistors 390, led's 375, and the first 75, second 95, third 115, fourth 135, and fifth 151 members all enclosed within the housing 290, also shown is the container 55, the interior volume 60 of the container 55, and the liquid level 70 that is at the secondary liquid level 230.

Broadly, the present invention is for a fluid level detection apparatus 50 for sensing a varying fluid level 70 of a liquid 65 within a container 55 interior volume 60, the fluid level detection apparatus 50 including a first member 75 having a first proximal end portion 80 and an opposing first distal end portion 85 with a first longitudinal axis 90 spanning therebetween, wherein the first member 75 is constructed of an electrically conductive material that is in an initial circuit state 155, see FIGS. 3 and 5. Further included in the fluid level detection apparatus is a second member 95 having a second proximal end portion 100 and an opposing second distal end portion 105 with a second longitudinal axis 110 spanning therebetween, wherein the second member 95 is constructed of an electrically conductive material that is in an initial circuit state 155, again see FIGS. 3 and 5.

Continuing, also included in the fluid level detection apparatus 50 is control circuitry 160 that is operative to monitor and being in electrical communication 205 the first 80 and second 100 proximal end portions to produce a primary perceptible output 180 in response to the first 85 and second distal end 105 portions forming an auxiliary circuit state 165 from the initial circuit state 155, wherein operationally the first 85 and second 105 distal end portions are disposed 170 within the container 55 interior volume 60 moving from the initial circuit state 155 to the auxiliary circuit state 165 with a presence of the liquid 65 in the container 55 with the liquid 65 in contact 175 with the first 85 and second 105 distal end portions to ultimately indicate a primary liquid level 185, see FIGS. 1, 2, and 4.

Optionally for the fluid level detection apparatus 50, it can further comprise a third member 115 having a third proximal end portion 120 and an opposing third distal end portion 125 with a third longitudinal axis 130 spanning therebetween, wherein the third member 115 is constructed of an electrically conductive material that is in an initial circuit state 155, see FIG. 2, plus FIGS. 3 to 5. Wherein the first 90, second 110, and third 130 longitudinal axes are substantially parallel 190 to one another wherein the third distal end portion 125 extends along the third longitudinal axis 130 to a different length 195 than the first 85 and second 105 distal end portions wherein the third distal end portion 125 is disposed 200 within the container 55 interior volume 60 and the third proximal end portion 120 is in electrical communication 210 with the control circuitry 160 to operationally produce a secondary perceptible output 225 in response to the first 85 and third 125 distal end portions forming 220 an auxiliary circuit state 165 from the initial circuit state 155 to ultimately indicate a secondary perceptible output 225 indicative of a secondary liquid level 230, see FIG. 2 plus FIG. 5.

Noting that with the first 75, second 95, and third 115 members, a plurality of progressive liquid 65 levels 70 are achieved via the primary perceptible output 180 and the secondary perceptible output 225 to indicate a proportional consumption of the liquid 65 in the container 55 interior volume 60 with varying liquid 65 levels 70 of the primary 185 and the secondary 230 liquid 65 levels 70, with the first 75, second 95, and third 115 members being preferably flexible and not affixed to the container 55 itself, wherein typical prior art fluid level sensors are affixed in some manner to the container to function properly, see in particular FIG. 1 and FIGS. 3 to 5.

Another option for the fluid level detection apparatus 50, wherein it can further comprise a fourth member 135 having a fourth proximal end portion 140 and an opposing fourth distal end portion 145 with a fourth longitudinal axis 150 spanning therebetween, wherein the fourth member 135 is constructed of an electrically conductive material that is in an initial circuit state 155, see FIG. 2 plus FIGS. 3 to 5. Wherein the first 90, second 110, third 130, and fourth 150 longitudinal axes are substantially parallel 235 to one another wherein the fourth distal end portion 145 extends along the fourth longitudinal axis 150 to a different length 240 than the first 85, second 105, and third 125 distal end portions wherein the fourth distal end portion 145 is disposed 201 within the container 55 interior volume 60 and the fourth proximal end portion 140 is in electrical communication 215 with the control circuitry 170 to operationally produce a tertiary perceptible output 250 in response to the first 85 and fourth 145 distal end portions forming 245 an auxiliary circuit state 165 from the initial circuit state 155 to ultimately indicate a tertiary perceptible output 250 indicative of a tertiary liquid level 255, see FIG. 2 plus FIG. 3.

Noting that with the first 75, second 95, third 115, and fourth 135 members, a plurality of progressive liquid 65 levels 70 are achieved via the primary 180, secondary 225, and tertiary 250 perceptible outputs to indicate a proportional consumption of the liquid 65 in the container 55 interior volume 60 with varying liquid 65 levels 70 of the primary 185, the secondary 230, and the tertiary 255, liquid 65 levels 70, with the first 75, second 95, third 115, and fourth 135 members being preferably flexible and not affixed to the container 55 itself, wherein typical prior art fluid level sensors are affixed in some manner to the container to function properly, see in particular FIGS. 1 and 3 to 5.

Another option for the fluid level detection apparatus 50, is that it can further comprise a fifth member 151 having a fifth proximal end portion 152 and an opposing fifth distal end portion 153 with a fifth longitudinal axis 154 spanning therebetween, wherein the fifth member 151 is constructed of an electrically conductive material that is in an initial circuit state 155, see FIG. 2 plus FIGS. 3 to 5. Wherein the first 90, second 110, third 130, fourth 150, and fifth 154 longitudinal axes are substantially parallel 236 to one another wherein the fifth distal end portion 153 extends along the fifth longitudinal axis 154 to a different length 241 than the first 85, second 105, third 125, and fourth 145 distal end portions. Wherein the fifth distal end portion 153 is disposed 202 within the container 55 interior volume 60 and the fifth proximal end portion 152 is in electrical communication 216 with the control circuitry 170 to operationally produce a fourth perceptible output 251 in response to the first 85 and fifth 153 distal end portions forming 246 an auxiliary circuit state 165 from the initial circuit state 155 to ultimately indicate a fourth perceptible output 251 indicative of a tertiary liquid level 256, see FIG. 2 plus FIG. 3.

Noting that with the first 75, second 95, third 115, fourth 135, and fifth 151 members, a plurality of progressive liquid 65 levels 70 are achieved via the primary 180, secondary 225, tertiary 250, and fourth 251 perceptible outputs to indicate a proportional consumption of the liquid 65 in the container 55 interior volume 60 with varying liquid 65 levels 70 of the primary 185, the secondary 230, the tertiary 255, and the fourth 256 liquid 65 levels 70, with the first 75, second 95, third 115, fourth 135, and fifth 151 members being preferably flexible and not affixed to the container 55 itself, wherein typical prior art fluid level sensors are affixed in some manner to the container to function properly, see in particular FIGS. 1 and 3 to 5.

As a further option for the fluid level detection apparatus 50, wherein the primary 180 and secondary 225 perceptible outputs can be a visual display 260, see all FIGS. 1 to 5. Another option for the fluid level detection apparatus 50, wherein the visual display 260 can include a plurality of lights 265, wherein the plurality of lights 265 are in electrical communication 270 with the control circuitry 160 to operationally correspond with distinguishing the primary liquid level 185 and the secondary liquid level 230, see all FIGS. 1 to 5.

Continuing on options for the fluid level detection apparatus 50, wherein the plurality of lights 265 are each being a different color wherein the plurality of different colored lights 280 are in electrical communication 285 with the control circuitry 160 and each of the lights being in electrical communication 285 with each of the second 100 and third 120 proximal end portions of the second 95 and third 115 members to operationally have a single light color 375 correspond with the primary liquid level 185 and the secondary liquid level 230, see FIGS. 3 to 5. In addition, the tertiary 250 and fourth 251 perceptible outputs can be added together or separate to the visual display 260 that can be a plurality of lights 265 wherein each of the plurality of lights can be a like color or different colors. Further optionally, on the fluid level detection apparatus 50, wherein the control circuitry 160 can be disposed within a housing 290 with an independent power supply 295 to operationally be portable and self contained, see FIGS. 3 to 5.

The initial circuit state 155 can be either a closed circuit state or an open circuit state as the auxiliary circuit state 165 can be either a closed circuit state or an open circuit state, however, when used together the initial circuit state 155 and the auxiliary circuit state 165 are opposite to one another such that if the initial circuit state 155 is the open circuit state then the auxiliary circuit 165 is the closed circuit state or if the initial circuit state 155 is the closed circuit state then the auxiliary circuit 165 is the open circuit state.

Yet another option for the fluid level detection apparatus 50, in looking at FIGS. 1 and 2 in particular, can include the open end frustoconical shape 305 transitioning to a reduced size outlet 310, wherein the reduced size outlet 310 transitions to a liquid communication line 315 that terminates at a line end portion 320, wherein the line end portion 320 is disposed within the container 55 interior volume 60 for an operational purpose of refilling 300 the container 55 interior volume 60 with the liquid 65 therethrough the open end of the frustoconical shape 305, wherein the first 75 and second 95 members are affixed adjacent 330 to the liquid communication line 315 positioned such that the first 85 and second 105 distal end portions are adjacent 335 to the line end portion 320, wherein the control circuitry 160 is affixed adjacent 340 to either the liquid communication line 315, the frustoconical shape 305, or both the liquid communication line 315 and the frustoconical shape 305.

### CONCLUSION

Accordingly, the present invention of the fluid level detection apparatus has been described with some degree of particularity directed to the embodiments of the present invention. It should be appreciated, though, that the present invention is defined by the following claims construed in light of the prior art so modifications the changes may be made to the exemplary embodiments of the present invention without departing from the inventive concepts contained therein.

1. A fluid level detection apparatus for sensing a varying fluid level of a liquid in within a container interior volume, said fluid level detection apparatus comprising:
(a) a first member having a first proximal end portion and an opposing first distal end portion with a first longitudinal axis spanning therebetween, wherein said first member is constructed of an electrically conductive material that is in an initial circuit state;
(b) a second member having a second proximal end portion and an opposing second distal end portion with a second longitudinal axis spanning therebetween, wherein said second member is constructed of an electrically conductive material that is in an initial circuit state; and
(c) control circuitry that is operative to monitor said first and second proximal end portions to produce a primary perceptible output in response to said first and second distal end portions forming an auxiliary circuit state from said initial circuit state, wherein operationally said first and second distal end portions are disposed within the container interior volume moving from said initial circuit state to said auxiliary circuit state with a presence of the liquid in the container with the liquid in contact with said first and second distal end portions to ultimately indicate a primary liquid level.

2. A fluid level detection apparatus according to claim 1 further comprising a third member having a third proximal end portion and an opposing third distal end portion with a third longitudinal axis spanning therebetween, wherein said third member is constructed of an electrically conductive material that is in an initial circuit state, wherein said first, second, and third longitudinal axes are substantially parallel to one another wherein said third distal end portion extends along said third longitudinal axis to a different length than said first and second distal end portions wherein said third distal end portion is disposed within the container interior volume and said third proximal end portion is in electrical communication with said control circuitry to operationally produce a secondary perceptible output in response to said first and third distal end portions forming an auxiliary circuit state from said initial circuit state to ultimately indicate a secondary perceptible output indicative of a secondary liquid level.

3. A fluid level detection apparatus according to claim 2 further comprising a fourth member having a fourth proximal end portion and an opposing fourth distal end portion with a fourth longitudinal axis spanning therebetween, wherein said fourth member is constructed of an electrically conductive material that is in an initial circuit state, wherein said first, second, third, and fourth longitudinal axes are substantially parallel to one another wherein said fourth distal end portion extends along said fourth longitudinal axis to a different length than said first, second, and third distal end portions wherein said fourth distal end portion is disposed within the container interior volume and said fourth proximal end portion is in electrical communication with said control circuitry to operationally produce a tertiary perceptible output in response to said first and fourth distal end portions forming an auxiliary circuit state from said initial circuit state to ultimately indicate a tertiary perceptible output indicative of a tertiary liquid level.

4. A fluid level detection apparatus according to claim 2 wherein said primary and secondary perceptible outputs are a visual display.

5. A fluid level detection apparatus according to claim 4 wherein said visual display includes a plurality of lights, wherein said plurality of lights are in electrical communication with said control circuitry to operationally correspond with distinguishing said primary liquid level and said secondary liquid level.

6. A fluid level detection apparatus according to claim 5 wherein said plurality of lights are each being a different color wherein said plurality of lights are in electrical communication with said control circuitry and each of said lights being in electrical communication with each of said second and third proximal end portions of said second and third members to operationally have a single light color correspond with said primary liquid level and said secondary liquid level.

7. A fluid level detection apparatus according to claim 2 wherein said control circuitry is disposed within a housing with an independent power supply to operationally be portable and self contained.

8. A fluid level detection apparatus for sensing and maintaining a varying fluid level of a liquid in within a container interior volume, said fluid level detection apparatus comprising:
(a) a first member having a first proximal end portion and an opposing first distal end portion with a first longitudinal axis spanning therebetween, wherein said first member is constructed of an electrically conductive material that is in an initial circuit state;
(b) a second member having a second proximal end portion and an opposing second distal end portion with a second longitudinal axis spanning therebetween, wherein said second member is constructed of an electrically conductive material that is in an initial circuit state;
(c) control circuitry that is operative to monitor said first and second proximal end portions to produce a primary perceptible output in response to said first and second distal end portions forming an auxiliary circuit state from said initial circuit state, wherein operationally said first and second distal end portions are disposed within the container interior volume moving from said initial circuit state to said auxiliary circuit state with a presence of the liquid in the container with the liquid in contact with said first and second distal end portions to ultimately indicate a primary liquid level; and
(d) an open end frustoconical shape transitioning to a reduced size outlet, wherein said reduced size outlet transitions to a liquid communication line that terminates at a line end portion, wherein said line end portion is disposed within the container interior volume for an operational purpose of refilling the container interior volume with the liquid therethrough said open end of said frustoconical shape, wherein said first and second members are affixed adjacent to said liquid communication line positioned such that said first and second distal end portions are adjacent to said line end portion, wherein said control circuitry is affixed adjacent to either said liquid communication line, said frustoconical shape, or both said liquid communication line and said frustoconical shape.

9. A fluid level detection apparatus according to claim 8 further comprising a third member having a third proximal end portion and an opposing third distal end portion with a third longitudinal axis spanning therebetween, wherein said third member is constructed of an electrically conductive material that is in an initial circuit state, wherein said first, second, and third longitudinal axes are substantially parallel to one another wherein said third distal end portion extends along said third longitudinal axis to a different length than said first and second distal end portions wherein said third distal end portion is disposed within the container interior volume and said third proximal end portion is in electrical communication with said control circuitry to operationally produce a secondary perceptible output in response to said first and third distal end portions forming an auxiliary circuit state from said initial circuit state to ultimately indicate a secondary perceptible output indicative of a secondary liquid level, wherein said third member is affixed adjacent to said first and second members.

10. A fluid level detection apparatus according to claim 9 further comprising a fourth member having a fourth proximal end portion and an opposing fourth distal end portion with a fourth longitudinal axis spanning therebetween, wherein said fourth member is constructed of an electrically conductive material that is in an initial circuit state, wherein said first, second, third, and fourth longitudinal axes are substantially parallel to one another wherein said fourth distal end portion extends along said fourth longitudinal axis to a different length than said first, second, and third distal end portions wherein said fourth distal end portion is disposed within the container interior volume and said fourth proximal end portion is in electrical communication with said control circuitry to operationally produce a tertiary perceptible output in response to said first and fourth distal end portions forming an auxiliary circuit state from said initial circuit state to ultimately indicate a tertiary perceptible output indicative of a tertiary liquid level, wherein said fourth member is affixed adjacent to said first, second, and third members.

11. A fluid level detection apparatus according to claim 9 wherein said primary and secondary perceptible outputs are a visual display.

12. A fluid level detection apparatus according to claim 11 wherein said visual display includes a plurality of lights, wherein said plurality of lights are in electrical communication with said control circuitry to operationally correspond with distinguishing said primary liquid level and said secondary liquid level.

13. A fluid level detection apparatus according to claim 12 wherein said plurality of lights are each being a different color wherein said plurality of lights are in electrical communication with said control circuitry and each of said lights being in electrical communication with each of said second and third proximal end portions of said second and third members to operationally have a single light color correspond with said primary liquid level and said secondary liquid level.

14. A fluid level detection apparatus according to claim 9 wherein said control circuitry is disposed within a housing with an independent power supply to operationally be portable and self contained.
